(19) United States
(12) Patent Application Publication
(10) Pub. No.: US 2025/0249653 A1
(43) Pub. Date: Aug. 7, 2025

(54) MULTI-LAYERED STRUCTURE AND METHOD OF MANUFACTURING THE SAME

(71) Applicant: SHARP KABUSHIKI KAISHA, Osaka (JP)

(72) Inventor: HIROYUKI HIRAKAWA, Osaka (JP)

(21) Appl. No.: 19/017,289

(22) Filed: Jan. 10, 2025

(30) Foreign Application Priority Data
Feb. 5, 2024 (JP) 2024-015925

(51) Int. Cl. B32B 3/30; B32B 27/08; B32B 27/32

(52) U.S. Cl. CPC B32B 3/30; B32B 27/08; B32B 27/32; B32B 2307/536

(57) ABSTRACT

A structure includes a first resin portion shaped of a first resin and a second resin portion shaped of a second resin, and is shaped by laminating a plurality of layers in a bonding direction. A bonding region in which both resin materials of the first resin portion and the second resin portion are mixed is provided between the first resin portion and the second resin portion, and in the bonding region, the first resin portion is provided with a protruding portion, the second resin portion is provided with a recessed portion having the same shape as the protruding portion, and the protruding portion is fitted into the recessed portion so that the first resin portion and the second resin portion are bonded to each other.

### INCORPORATION BY REFERENCE

This application claims priority under Section 119 of U.S.C. to Japanese Patent Application No. 2024-015925 filed on Feb. 5, 2024, the entire content of which is incorporated herein by reference.

### BACKGROUND

The present disclosure relates to a multi-layered structure formed by bonding different resin materials and a method of manufacturing the same.

In recent years, shaping of a structure by using a three dimensional shaping method has been performed, and shaping using different types of resin materials may be performed. JP 2017-025187 A discloses a method of shaping a multi-layered structure formed by bonding two types of resin materials by forming a parallel cross structure by using a three dimensional shaping apparatus (so-called 3D printer).

### SUMMARY

In order to solve the above-mentioned problems, a multi-layered structure according to a first aspect of the present disclosure includes a first resin portion shaped of a first resin, and a second resin portion shaped of a second resin which is a resin material different from the first resin, in which the multi-layered structure is shaped by laminating a plurality of layers in a bonding direction, a bonding region in which both resin materials of the first resin portion and the second resin portion are mixed is provided between the first resin portion and the second resin portion, in the bonding region, the first resin portion is provided with a protruding portion, the second resin portion is provided with a recessed portion having the same shape as the protruding portion, and the first resin portion and the second resin portion are bonded to each other by fitting the protruding portion into the recessed portion, the protruding portion includes a plurality of first rod-shaped portions that each extend in the bonding direction and a plurality of second rod-shaped portions that each extend from the first rod-shaped portion from the same position in a direction intersecting the bonding direction, the second rod-shaped portion is formed so as to be connected to the plurality of first rod-shaped portions, and the bonding region has a structure in which a first layer in which the second rod-shaped portion is present and a second layer in which the second rod-shaped portion is not present are repeatedly multi-layered in order along the bonding direction.

According to the above configuration, the protruding portion of the first resin portion is fitted into the recessed portion of the second resin portion in the bonding region, so that a strong mechanical bonding is obtained. In particular, in the protruding portion, the first rod-shaped portion and the second rod-shaped portion whose longitudinal directions are orthogonal to each other intersect with each other to form a matrix structure, and in the recessed portion, a bulk all connected without an isolated portion is formed while sandwiching the matrix structure of the protruding portion. As a result, in the bonding region, a portion that is likely to be locally separated is less likely to be formed, and an extremely strong bonding structure is obtained.

The multi-layered structure according to a second aspect of the present disclosure includes a first resin portion shaped of a first resin, and a second resin portion shaped of a second resin which is a resin material different from the first resin, in which the multi-layered structure is shaped by laminating a plurality of layers in a bonding direction, a bonding region in which both resin materials of the first resin portion and the second resin portion are mixed is provided between the first resin portion and the second resin portion, in the bonding region, the first resin portion is provided with a protruding portion, the second resin portion is provided with a recessed portion having the same shape as the protruding portion, and the first resin portion and the second resin portion are bonded to each other by fitting the protruding portion into the recessed portion, the protruding portion includes a plurality of first rod-shaped portions that each extend in the bonding direction and a plurality of lump portions each formed so as to surround a periphery of a side surface of a part of the first rod-shaped portion in the longitudinal direction, and the bonding region has a structure in which a layer in which the lump portion is present and a layer in which the lump portion is not present are repeatedly multi-layered in order along the bonding direction.

According to the above configuration, the protruding portion of the first resin portion is fitted into the recessed portion of the second resin portion in the bonding region, so that a strong mechanical bonding is obtained. In the lump portion, a protruding amount from the first rod-shaped portion is small, and thus the first resin forming the lump portion is well separated from the nozzle at the time of shaping, and shaping becomes easy.

In addition, the multi-layered structure may be configured such that, in the bonding region, a mixing ratio of the first resin to the second resin changes along the bonding direction, a ratio of the first resin portion decreases from the first resin portion side toward the second resin portion side, and a ratio of the second resin portion increases from the first resin portion side toward the second resin portion side. In this case, the multi-layered structure may be configured such that, in the bonding region, the thickness of the second rod-shaped portion decreases from the first resin portion side toward the second resin portion side. Alternatively, the multi-layered structure may be configured such that, in the bonding region, the size of the lump portion decreases from the first resin portion side toward the second resin portion side.

According to the configuration described above, gradation can be provided so that the mixing ratio of the first resin to the second resin in the bonding region is changed along the bonding direction. As a result, the stress is dispersed in the bonding region and a local stress concentration is suppressed, so that breakage of the structure due to the stress concentration is less likely to occur.

In addition, the multi-layered structure may be configured such that the first resin is a resin material that is relatively harder than the second resin. In this case, the multi-layered structure may be configured such that the first resin is an ABS resin, and the second resin is a PP resin or a PE resin.

The multi-layered structure may include at least one first resin portion and at least two second resin portions, or at least two first resin portions and at least one second resin portion. The multi-layered structure may be configured such that a bonding structure that forms the bonding region is formed at at least one bonding portion between the first resin portion and the second resin portion, and the multi-layered structure in which surfaces of the first resin portion and the second resin portion are merely in contact with each other without forming the bonding region is formed at at least one other bonding portion between the first resin portion and the second resin portion.

According to the above configuration, in the bonding portion between the first resin portion and the second resin portion forming the bonding structure, a strong and integral bond can be obtained. On the other hand, in the bonding portion between the first resin portion and the second resin portion forming the multi-layered structure, a joint surface between the first resin portion and the second resin portion is easily separated after shaping, and the bonding portion can be used as a movable portion. Thus, a joint mechanism or the like including the movable portion can be obtained by a single shaping operation.

A method of manufacturing a multi-layered structure according to a third aspect of the present disclosure, the multi-layered structure including a first resin portion shaped of a first resin and a second resin portion shaped of a second resin which is a resin material different from the first resin, and the multi-layered structure being shaped by laminating a plurality of layers in a bonding direction, the method includes providing a bonding region in which both resin materials of the first resin portion and the second resin portion are mixed between the first resin portion and the second resin portion, in the bonding region, providing the first resin portion with a protruding portion, providing the second resin portion with a recessed portion having the same shape as the protruding portion, and bonding the first resin portion and the second resin portion to each other by fitting the protruding portion into the recessed portion, the protruding portion including a plurality of first rod-shaped portions that each extend in the bonding direction and a plurality of second rod-shaped portions that each extend from the first rod-shaped portion from the same position in a direction intersecting the bonding direction, forming the second rod-shaped portion to be connected to the plurality of first rod-shaped portions, and forming the bonding region by repeatedly laminating a first layer in which the second rod-shaped portion is present and a second layer in which the second rod-shaped portion is not present in order along the bonding direction.

A method of manufacturing a multi-layered structure according to a fourth aspect of the present disclosure, the multi-layered structure including a first resin portion shaped of a first resin and a second resin portion shaped of a second resin which is a resin material different from the first resin, and the multi-layered structure being shaped by laminating a plurality of layers in a bonding direction, the method includes providing a bonding region in which both resin materials of the first resin portion and the second resin portion are mixed between the first resin portion and the second resin portion, in the bonding region, providing the first resin portion with a protruding portion, providing the second resin portion with a recessed portion having the same shape as the protruding portion, and bonding the first resin portion and the second resin portion to each other by fitting the protruding portion into the recessed portion, the protruding portion including a plurality of first rod-shaped portions that each extend in the bonding direction and a plurality of lump portions each formed so as to surround a periphery of a side surface of a part of the first rod-shaped portion in the longitudinal direction, and forming the bonding region by repeatedly laminating a layer in which the lump portion is present and a layer in which the lump portion is not present in order along the bonding direction.

### BRIEF DESCRIPTION OF DRAWINGS

FIG. 1 is a view for explaining a shaping method using a 3D printer including two nozzles.

FIG. 2 is a view illustrating a structure example of a multi-layered structure that can be shaped using the 3D printer.

FIG. 3 is a view illustrating a structure example of a multi-layered structure that can be shaped using the 3D printer.

FIG. 4 is a view illustrating a structure in a first embodiment.

FIG. 5 is a side view illustrating the structure in the first embodiment.

FIG. 6 is a view illustrating a structure in a second embodiment.

FIG. 7 is a side view illustrating the structure in the second embodiment.

FIG. 8 is a view illustrating a structure having a parallel cross structure without gradation as a comparative example.

FIG. 9 is a view illustrating a structure having a parallel cross structure with gradation as a comparative example.

FIG. 10 is a view illustrating a structure in a third embodiment.

FIG. 11 is a side view illustrating the structure in the third embodiment.

FIG. 12 is an application example of a fourth embodiment and is an external view of a structure which is a ball joint.

FIG. 13 is another application example of the fourth embodiment and is an external view of a structure which is a cylinder type joint.

### DESCRIPTION OF EMBODIMENTS

An embodiment according to the disclosure will be described in detail below with reference to the drawings. A multi-layered structure according to the present embodiment is formed by bonding two types of resin materials, and shaping using a so-called 3D printer is assumed.

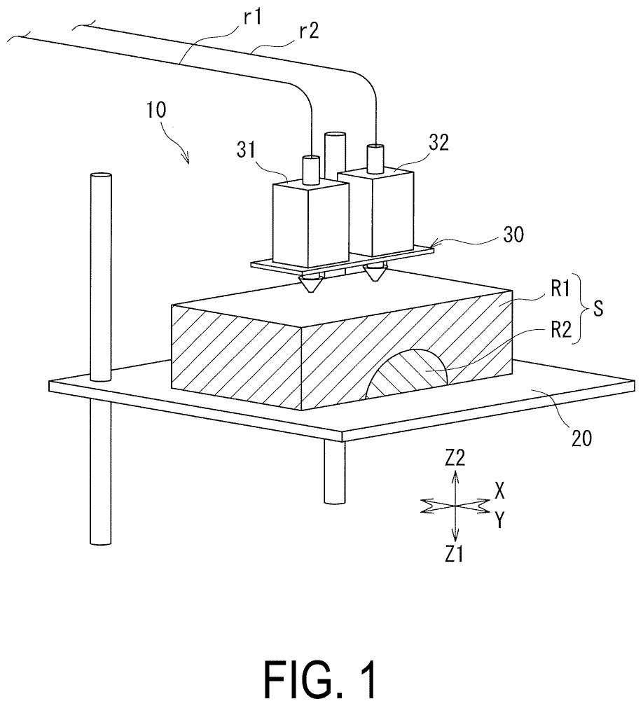

First, a basic shaping method (molten resin extrusion shaping method) using the 3D printer in the present embodiment will be described. FIG. 1 is a view for explaining a shaping method using a 3D printer 10 including two nozzles 31 and 32. As illustrated in FIG. 1, the 3D printer 10 includes a platform 20 and an extrusion head 30 as main components. The platform 20 is a table on which a structure to be shaped is placed, and is movable in a vertical direction (Z1-Z2 direction).

The extrusion head 30 includes two nozzles 31 and 32, a first resin filament r1 is supplied to the nozzle 31, and a second resin filament r2 is supplied to the nozzle 32. The nozzles 31 and 32 melt the supplied resin filaments and inject molten resins thereof onto the platform 20 by extruding the molten resins. The extrusion head 30 is movable in a horizontal plane (in an XY plane), and a resin layer of any pattern can be drawn on the platform 20 by injecting the molten resin from the nozzles 31 and 32 at any timing while moving the extrusion head 30. It is needless to say that the resin layer of any pattern can be drawn in the same manner even in an apparatus configuration in which the extrusion heads are individually provided for the two nozzles 31 and 32.

When the resin layer of any pattern is drawn on the platform 20, the 3D printer 10 is lowered (moved in a Z1 direction) by a predetermined amount, and the resin layer is further drawn thereon, so that a plurality of the resin layers of any pattern are multi-layered and shaped to obtain a multi-layered structure S (hereinafter referred to as a structure S). In the structure S, a portion where the molten resin injected from the nozzle 31 is cured becomes a first resin portion R1, and a portion where the molten resin injected from the nozzle 32 is cured becomes a second resin portion R2.

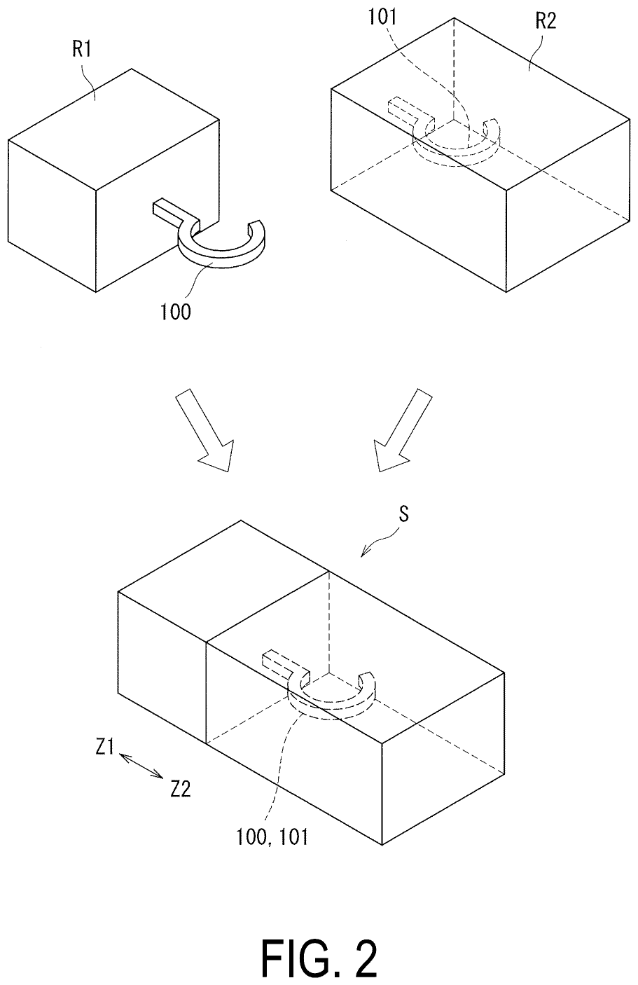

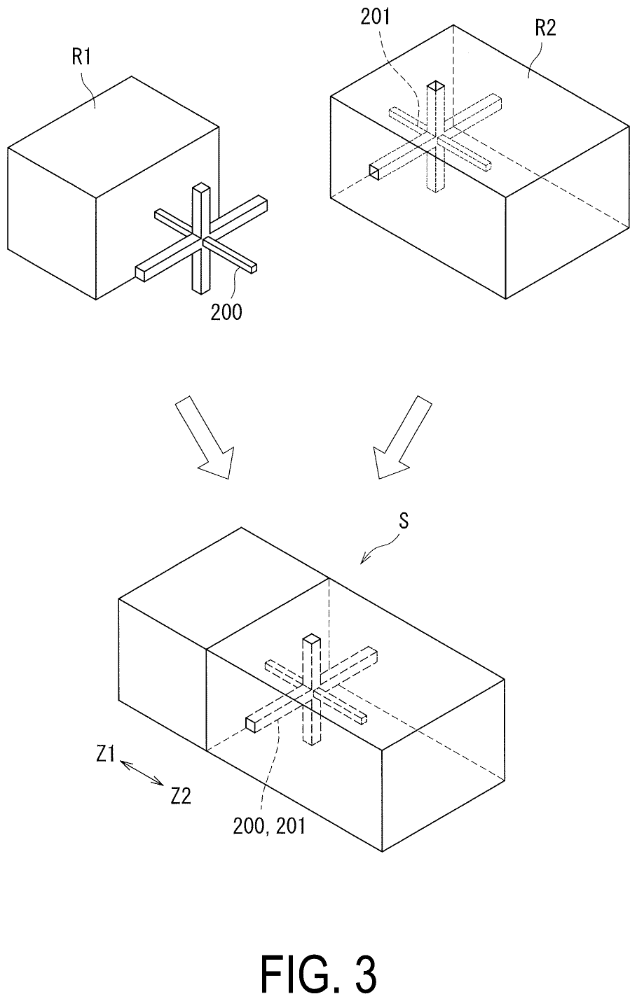

FIGS. 2 and 3 are views each illustrating a structure example of the structure S that can be shaped using the 3D printer 10. Note that the Z1-Z2 direction in FIGS. 2 and 3 can be made to coincide with a moving direction (vertical direction) of the platform 20 in FIG. 1.

In the structure example of FIG. 2, the first resin portion R1 is provided with a protruding portion 100 having a hook shape, and the second resin portion R2 is provided with a recessed portion 101 having the same shape as the protruding portion 100. In the structure S in which the first resin portion R1 and the second resin portion R2 are combined with each other to be bonded, the protruding portion 100 is fitted into the recessed portion 101 without any clearance, so that the first resin portion R1 and the second resin portion R2 are suppressed from being separated from each other even when compatibility between the first and second resins is low.

In the structure example of FIG. 3, the first resin portion R1 is provided with a protruding portion 200 having a tree shape, and the second resin portion R2 is provided with a recessed portion 201 having the same shape as the protruding portion 200. Also, in the structure S of FIG. 3, the protruding portion 200 is fitted into the recessed portion 201, so that the first and second resin portions R1 and R2 are suppressed from being separated from each other.

### First Embodiment

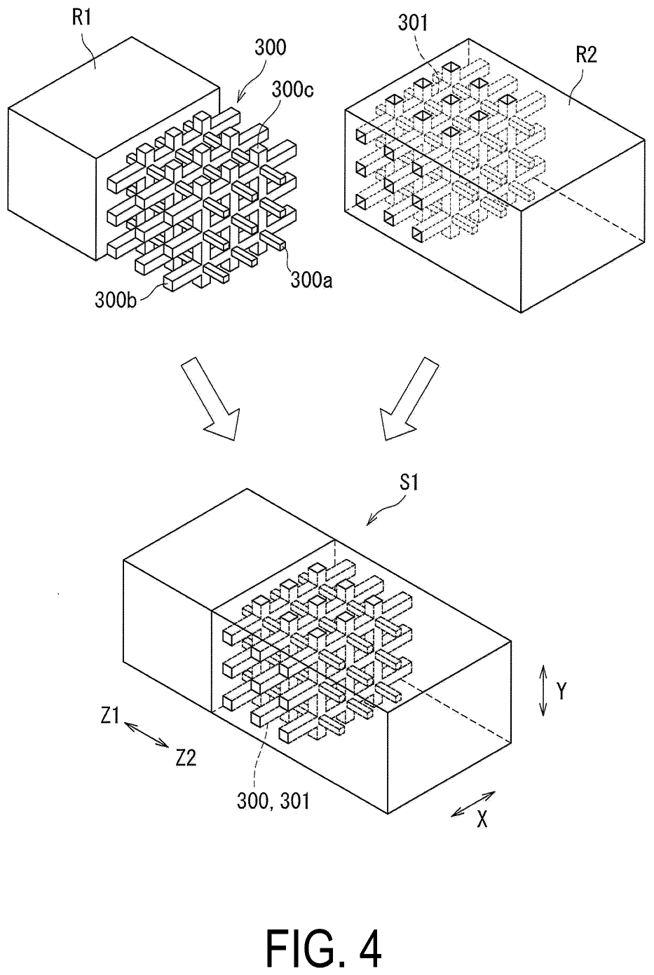

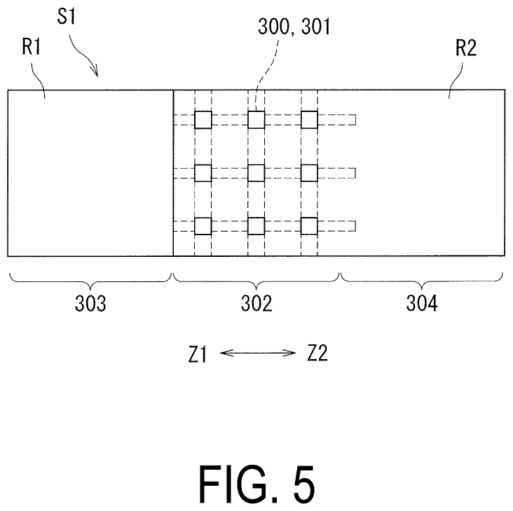

FIG. 4 is a view illustrating a structure S1 in a first embodiment of the disclosure. FIG. 5 is a side view of the structure S1. In the structure S1 of the present embodiment, the first resin portion R1 is provided with a protruding portion 300 imitating an underground stem structure of plants, and the second resin portion R2 is provided with a recessed portion 301 having the same shape as the protruding portion 300.

As illustrated in FIGS. 4 and 5, the structure S1 is formed by disposing the first resin portion R1 and the second resin portion R2 along a predetermined bonding direction (Z1-Z2 direction) and joining these two resin portions. In the present embodiment, the first resin portion R1 is disposed on the left side (Z1 direction side) in the drawing, and the second resin portion R2 is disposed on the right side (Z2 direction side) in the drawing. Further, a bonding region 302 in which both resin materials of the first resin portion R1 and the second resin portion R2 are mixed is present between the first resin portion R1 and the second resin portion R2 in the Z1-Z2 direction. That is, the bonding region 302 is a region formed by fitting the protruding portion 300 of the first resin portion R1 into the recessed portion 301 of the second resin portion R2. Here, a region on the first resin portion R1 side (Z1 direction side) with respect to the bonding region 302 is a first resin region 303 made of only the first resin. In addition, a region on the second resin portion R2 side (Z2 direction side) with respect to the bonding region 302 is a second resin region 304 made of only the second resin.

Although the bonding direction (Z1-Z2 direction) in FIGS. 4 and 5 can be made to coincide with the moving direction (vertical direction) of the platform 20 in FIG. 1, it is not always necessary to make the bonding direction in the structure S1 coincide with the moving direction (laminating direction) of the platform 20. For example, the laminating direction of the structure S1 may be an X direction or a Y direction in FIGS. 4 and 5. This also applies to structures S2 and S3 described later.

Hereinafter, a specific shape of the protruding portion 300 in the first resin portion R1 will be described. The protruding portion 300 includes a plurality of first rod-shaped portions 300a and a plurality of second rod-shaped portions 300b and 300c.

The first rod-shaped portion 300a is formed to extend from the first resin region 303 in the Z2 direction. The second rod-shaped portions 300b and 300c are formed so as to branch from the first rod-shaped portion 300a and extend in directions (the X direction and the Y direction) orthogonal to the first rod-shaped portion 300a. Here, the second rod-shaped portion extending in the X direction is referred to as the second rod-shaped portion 300b, and the second rod-shaped portion extending in the Y direction is referred to as the second rod-shaped portion 300c. In the protruding portion 300 of the present embodiment, the first rod-shaped portion 300a and the second rod-shaped portion 300b form a lattice, and similarly, the first rod-shaped portion 300a and the second rod-shaped portion 300c, and the second rod-shaped portion 300b and the second rod-shaped portion 300c respectively also form a lattice. In the present embodiment, the second rod-shaped portion 300b and the second rod-shaped portion 300c are formed so as to be connected to the plurality of first rod-shaped portions 300a. The first rod-shaped portion 300a, the second rod-shaped portion 300b, and the second rod-shaped portion 300c are disposed at equal intervals in the X, Y, and Z directions, respectively.

In the protruding portion 300, when the second rod-shaped portion 300b is present at a certain position in the bonding direction in the first rod-shaped portion 300a, the second rod-shaped portion 300c is also present at the same position. In the protruding portion 300, when the second rod-shaped portion 300b is not present at a certain position in the bonding direction in the first rod-shaped portion 300a, the second rod-shaped portion 300c is also not present at the same position. That is, the protruding portion 300 has a structure in which a layer (first layer) in which both of the second rod-shaped portions 300b and 300c are present and a layer (second layer) in which neither of the second rod-shaped portions 300b and 300c is present are repeatedly (alternately) multi-layered in order along the bonding direction.

As described above, in the protruding portion 300, the first rod-shaped portion 300a and the second rod-shaped portions 300b and 300c whose longitudinal directions are orthogonal to each other intersect with each other to be disposed in a matrix. The recessed portion 301 into which the protruding portion 300 is fitted forms a bulk all connected without an isolated portion while sandwiching the matrix structure of the protruding portion 300. As a result, in the bonding region 302, a portion that is likely to be locally separated is less likely to be formed.

In particular, in a layer in which neither of the second rod-shaped portions 300b and 300c is present in the protruding portion 300, a structure in which the second resin is annularly continuous is formed at the outermost periphery of the bonding region 302. As described above, a structural portion in which the second resin is annularly continuous is naturally less likely to be separated in a circumferential direction due to resin peeling, and contributes to improvement in the strength of the bonding region 302.

In the above-described structure S1, the protruding portion 300 of the first resin portion R1 is fitted into the recessed portion 301 of the second resin portion R2 in the bonding region 302, so that a strong mechanical bonding is obtained. As a result, even when the compatibility of the first and second resins used as the materials of the structure S1 is low, the first and second resin portions R1 and R2 can obtain high resistance against a tensile force in the bonding direction (Z1-Z2 direction) of the first and second resin portions R1 and R2. For example, a polypropylene (PP) resin and a polyethylene (PE) resin are promising materials as soft materials because of characteristics such as high strength, chemical resistance, and fatigue resistance. However, they are poor in compatibility with other resins and have a large thermal shrinkage rate, and thus it has been considered difficult to use them to be bonded to other resin materials in the molten resin extrusion shaping method. However, in a bonding method of the structure according to the present disclosure, a strong mechanical bonding can be obtained even with another resin having low compatibility, and thus the PP resin or the PE resin can be used.

In the structure S1 (and structures S2 and S3 to be described later), when the first and second resins have different hardnesses and one is harder than the other, it is preferable that the first resin portion R1 including the protruding portion 300 is made of a harder material (e.g., acrylonitrile-butadiene-styrene (ABS) resin) and the second resin portion R2 including the recessed portion 301 is made of a softer material (e.g., PP resin or PE resin).

This is due to the topological interpretation of the structure formed by the first resin and the second resin. The structure of the second resin portion R2 has a shape (for example, a shape like a numeral “8”) continuous without an end portion. On the other hand, the structure of the first resin portion R1 has a shape (for example, a shape like a numeral “4”) including a continuous bonding portion and further including a tip end. In terms of material mechanics, in a case of a more fragile resin material (soft resin material), it is preferable in terms of stress dispersion to select the shape continuous without the end portion such as the numeral “8”.

### Second Embodiment

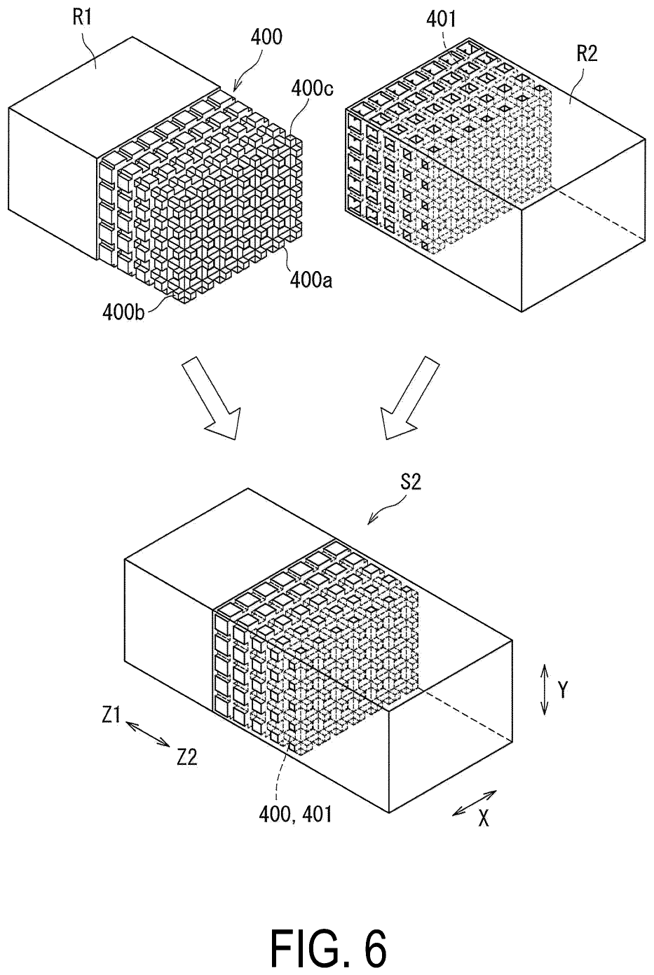

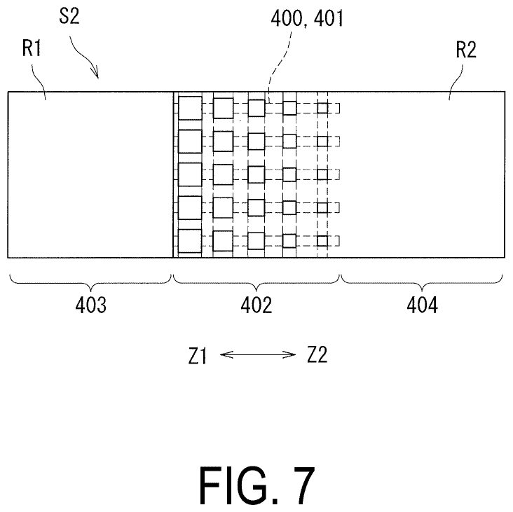

FIG. 6 is a view illustrating a structure S2 in a second embodiment of the disclosure. FIG. 7 is a side view of the structure S2. In the structure S2 of the present embodiment, the first resin portion R1 is provided with a protruding portion 400 imitating an underground stem structure of plants, and the second resin portion R2 is provided with a recessed portion 401 having the same shape as the protruding portion 400.

As illustrated in FIGS. 6 and 7, also in the structure S2, a bonding region 402 in which both resin materials of the first resin portion R1 and the second resin portion R2 are mixed is present between the first resin portion R1 and the second resin portion R2 in the Z1-Z2 direction. In the bonding region 402, the protruding portion 400 of the first resin portion R1 fits into the recessed portion 401 of the second resin portion R2. A region on the first resin portion R1 side (Z1 direction side) with respect to the bonding region 402 is a first resin region 403 made of only the first resin. In addition, a region on the second resin portion R2 side (Z2 direction side) with respect to the bonding region 402 is a second resin region 404 made of only the second resin.

The protruding portion 400 has a shape substantially similar to that of the protruding portion 300 in the first embodiment, and includes a plurality of first rod-shaped portion 400a and a plurality of second rod-shaped portion 400b and 400c. That is, the first rod-shaped portion 400a and the second rod-shaped portions 400b and 400c in the protruding portion 400 correspond to the first rod-shaped portion 300a and the second rod-shaped portions 300b and 300c in the protruding portion 300.

Here, the protruding portion 400 of the present embodiment is different from the protruding portion 300 of the first embodiment in that thicknesses of the second rod-shaped portions 400b and 400c change along the bonding direction (Z1-Z2 direction) of the first resin portion R1 and the second resin portion R2. To be specific, the thicknesses of the second rod-shaped portions 400b and 400c are thick on the first resin portion R1 side and decrease toward the second resin portion R2 side.

In the structure S2, the thicknesses of the second rod-shaped portions 400b and 400c change along the bonding direction, and thus gradation can be provided so that a mixing ratio of the first resin to the second resin in the bonding region 402 is changed along the bonding direction. To be specific, a ratio of the first resin portion decreases from the first resin portion R1 side toward the second resin portion R2 side. Relatively, a ratio of the second resin portion increases from the first resin portion R1 side toward the second resin portion R2 side. This provides an advantage that local stress concentration can be suppressed when stresses repeatedly act in an application of the structure S2.

The protruding portion 400 has a structure in which a layer (first layer) in which both the second rod-shaped portions 400b and 400c are present and a layer (second layer) in which neither of the second rod-shaped portions 400b and 400c is present are alternately multi-layered along the bonding direction, and thus the ratio of the first resin portion is large in the layer in which both the second rod-shaped portions 400b and 400c are present, and the ratio of the first resin portion is small in the layer in which neither of the second rod-shaped portions 400b and 400c is present. That is, strictly speaking, the ratio of the first resin portion decreases as a whole while repeatedly increasing and decreasing in a small cycle from the first resin portion R1 side toward the second resin portion R2 side. Thus, “the ratio of the first resin portion decreases from the first resin portion R1 side toward the second resin portion R2 side” is a concept including a case where the ratio decreases as a whole while repeatedly increasing and decreasing in a small cycle.

For example, in the structure S1 according to the first embodiment, the thicknesses of the second rod-shaped portions 300b and 300c do not change along the bonding direction. That is, the mixing ratio of the first resin to the second resin in the bonding region 302 is substantially constant (has no gradation) along the bonding direction. In this case, the mixing ratio of the first resin to the second resin rapidly changes at a boundary surface between the first resin region 303 and the bonding region 302 and at a boundary surface between the bonding region 302 and the second resin region 304. In such a case, when stresses repeatedly act on the structure S1, the stress concentration occurs on the surface where the mixing ratio of the first resin to the second resin changes, and the breakage of the structure is likely to occur on this surface.

On the other hand, in the structure S2 in the present embodiment, the mixing ratio of the first resin to the second resin in the bonding region 402 has the gradation, and thus even when the stresses repeatedly act on the structure S2, the stresses can be dispersed in the bonding region 402 and the local stress concentration can be suppressed. As a result, the breakage of the structure due to the stress concentration is less likely to occur.

The gradation structure in the mixing ratio of the first resin to the second resin can also be achieved by the parallel cross structure in Patent Literature 1, but the gradation of the structure S2 of the present embodiment has an advantage over the gradation by the parallel cross structure. Next, this will be described.

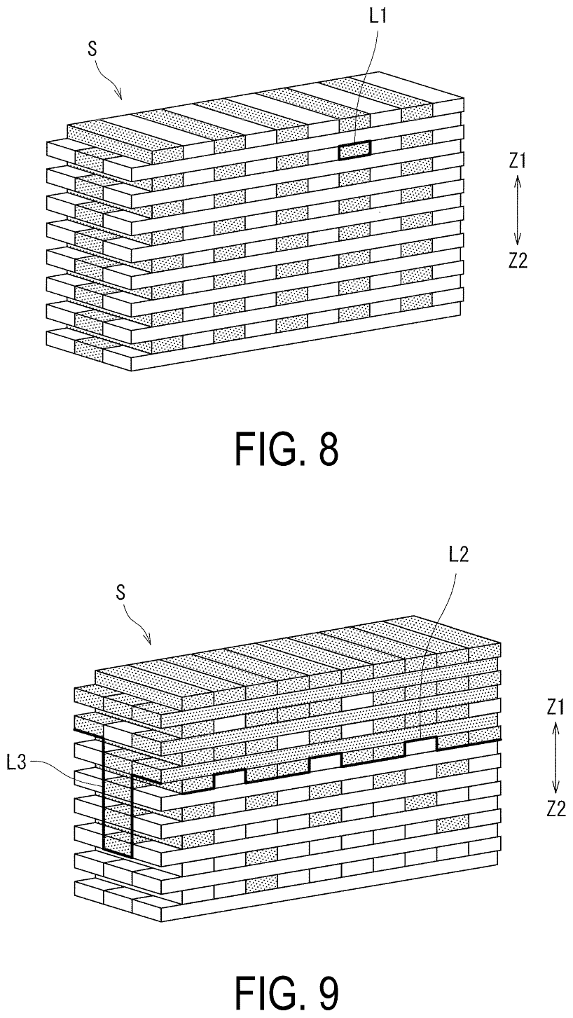

FIGS. 8 and 9 are perspective views each illustrating a parallel cross structure for comparison, FIG. 8 illustrates a structure S having no gradation, and FIG. 9 illustrates a structure S having the gradation. In FIGS. 8 and 9, a hatched portion is the first resin, and an unhatched portion is the second resin.

As illustrated in FIG. 8, in the structure S having no gradation, a boundary line between the first and second resins appearing on an outer surface of the structure appears as a boundary line L1 closed such that a periphery of one (the first resin material in this example) of the resin materials is surrounded by the other resin material (the second resin material in this example). In this case, the entire periphery of a block of the first resin inside the boundary line L1 is surrounded by the second resin, and thus the block is fixed by the second resin, so that peeling at the boundary line L1 is less likely to occur.

On the other hand, as illustrated in FIG. 9, in the structure S having the gradation, an arrangement pattern of the resin material is different in each layer to be multi-layered, and thus a boundary line L2 or a boundary line L3 opened and continuously connected between one side and the opposing other side of the outer surface are likely to be generated as the boundary lines between the first and second resins. At the same time, the bonding between the same kind of materials increases in the parallel cross structure, and a fitting structure in the bonding direction (Z1-Z2 direction) does not function. In the structure S of FIG. 9, when a tensile force is generated in the bonding direction (Z1-Z2 direction), material peeling is likely to occur at the boundary line L2 and the boundary line L3. When the structure S is used in a movable portion or the like and a motion is repeated, the peeling at the boundary line L2 or the boundary line L3 is eroded to the inside, and finally, there is also a possibility that breakage occurs.

On the other hand, in the structure S2 in the present embodiment, as illustrated in FIG. 7, the boundary line between the first and second resins appearing on the outer surface of the bonding region 402 is only a boundary line closed so as to surround the first resins with the second resins (there is no boundary line opened and continuously connected), as in the structure S of FIG. 8. Thus, in the structure S2, even when the mixing ratio of the resins has the gradation in the bonding region 402, the peeling at the boundary line between the first and second resins is less likely to occur.

### Third Embodiment

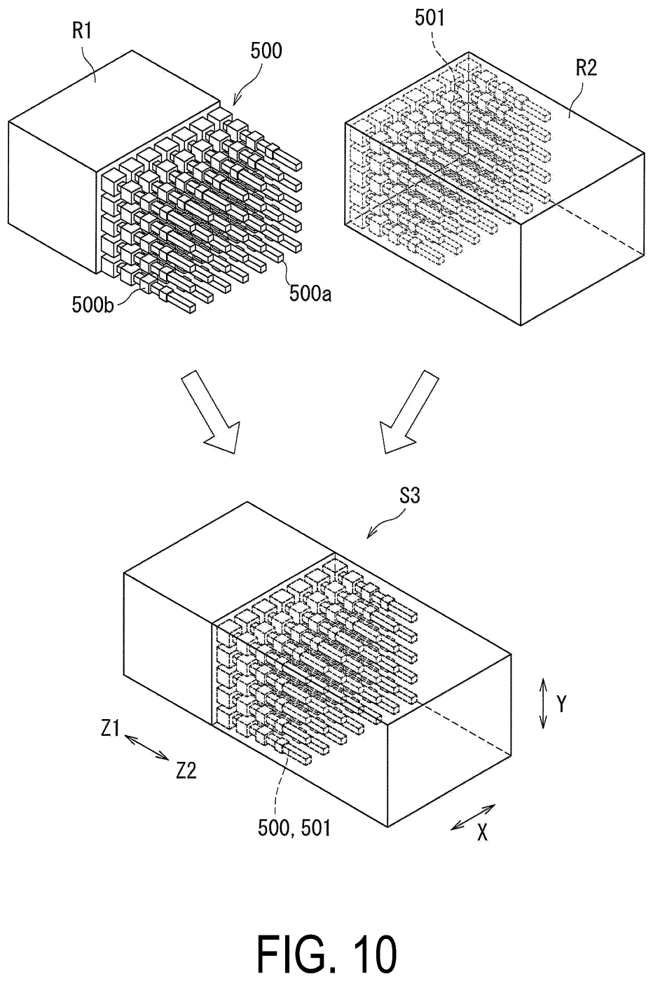

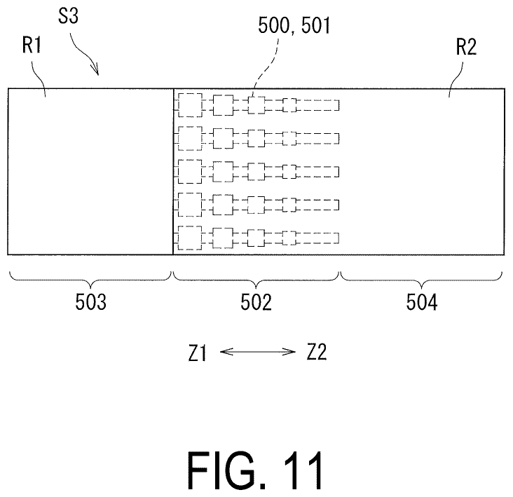

FIG. 10 is a view illustrating a structure S3 in a third embodiment of the disclosure. FIG. 11 is a side view of the structure S3. In the structure S3 of the present embodiment, the first resin portion R1 is provided with a protruding portion 500 imitating a corm structure of plants, and the second resin portion R2 is provided with a recessed portion 501 having the same shape as the protruding portion 500.

As illustrated in FIGS. 10 and 11, also in the structure S3, a bonding region 502 in which both resin materials of the first resin portion R1 and the second resin portion R2 are mixed is present between the first resin portion R1 and the second resin portion R2 in the Z1-Z2 direction. In the bonding region 502, the protruding portion 500 of the first resin portion R1 fits into the recessed portion 501 of the second resin portion R2. A region on the first resin portion R1 side (Z1 direction side) with respect to the bonding region 502 is a first resin region 503 made of only the first resin. In addition, a region on the second resin portion R2 side (Z2 direction side) with respect to the bonding region 502 is a second resin region 504 made of only the second resin.

The protruding portion 500 includes a plurality of first rod-shaped portions 500a and a plurality of lump portions 500b. Similarly to the first rod-shaped portions 300a and 400a in the first and second embodiments, the first rod-shaped portion 500a is formed to extend from the first resin region 503 in the Z2 direction. The lump portion 500b is formed so as to surround a periphery of the side surface of a part of the first rod-shaped portion 500a in the longitudinal direction (so that a part of the first rod-shaped portion 500a in the longitudinal direction expands). Preferably, the lump portion 500b is formed at a plurality of locations with respect to one first rod-shaped portion 500a. More preferably, the lump portion 500b is formed so as to expand from the first rod-shaped portion 500a in a rectangular parallelepiped shape in all directions in the XY plane. In the present embodiment, unlike the second rod-shaped portions 300b, 300c, 400b, and 400c in the first and second embodiments, the lump portion 500b is not connected to the plurality of first rod-shaped portions 500a. The rectangular parallelepiped is illustrated as the shape of the lump portion 500b here. However, the shape of the lump portion 500b is not particularly limited and may be, for example, a spherical shape.

In addition, the protruding portion 500 has a structure in which a layer (first layer) in which the lump portion 500b is present and a layer (second layer) in which the lump portion 500b is not present are repeatedly (alternately) multi-layered in order along the bonding direction.

In the above-described structure S3, the protruding portion 500 of the first resin portion R1 is fitted into the recessed portion 501 of the second resin portion R2 in the bonding region 502, so that a strong mechanical bonding is obtained. To be specific, the lump portion 500b functions as a wedge with respect to the second resin portion R2, and thus a high resistance with respect to a tensile force in the bonding direction (Z1-Z2 direction) can be obtained.

In particular, when the compatibility between the first and second resins is low, the structure S3 is more easily shaped than the structures S1 and S2. For example, in the structure S1, when the protruding amount of the second rod-shaped portions 300b and 300c from the first rod-shaped portion 300a is large, the first resin having a large length is placed on the second resin in the lower layer in the laminating direction, and the adhesion of the first resin to the second resin in the lower layer is low, and thus the first resin is not easily separated from the nozzle at the time of shaping, and shaping is difficult. On the other hand, in the structure S3, the protruding amount of the lump portion 500b from the first rod-shaped portion 500a is small, and thus the first resin forming the lump portion 500b is well separated from the nozzle at the time of shaping, and shaping becomes easy.

In addition, in the structure S3, the lump portion 500b does not connect the plurality of first rod-shaped portions 500a, and thus rigidity in the X direction and the Y direction can be made lower than the structures S1 and S2 in the first and second embodiments. As a result, the structure S3 can reduce resistance to bending or torsion in the bonding region 502, and can be expected to be suitable for applications requiring elastic bending or torsional deformation.

In the structure S3 illustrated in FIGS. 10 and 11, the size (volume) of the lump portion 500b changes along the bonding direction (Z1-Z2 direction) of the first resin portion R1 and the second resin portion R2. To be specific, the size of the lump portion 500b is large on the first resin portion R1 side and decreases toward the second resin portion R2 side. Similarly to the structure S2 of the second embodiment, this is a structure for providing the gradation in the mixing ratio of the first resin to the second resin in the bonding region 502. However, similarly to the structure S1 of the first embodiment, it is also possible to adopt a structure in which the gradation is not provided in the bonding region 502, and in this case, the lump portions 500b may be disposed in the same size and at equal intervals along the bonding direction (Z1-Z2 direction).

In the structure S3, an end surface of the protruding portion 500 is not exposed to the outer surface in the bonding region 502. In this case, an opening is not formed in the second resin constituting the outer surface of the bonding region 502, and even when bending is repeated at the structure S3, cracks are less likely to occur in a surface of the second resin in the bonding region 502.

### Fourth Embodiment

The structures S1 to S3 in the first and second embodiments have a rectangular parallelepiped shape. However, the shape of the structure S of the present disclosure is not particularly limited, and the shape of the structure S varies depending on the use of the structure S.

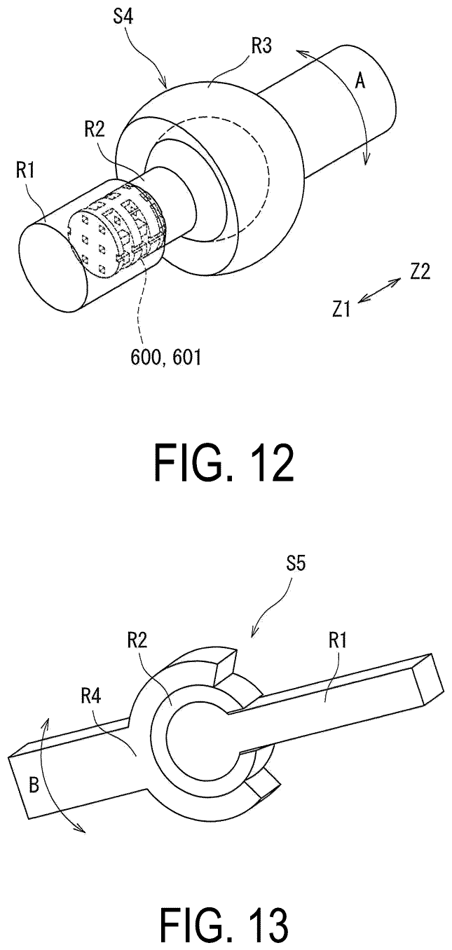

FIG. 12 is an application example of a fourth embodiment and is an external view of a structure S4 which is a ball joint. The structure S4 which is the ball joint is configured to include one first resin portion R1 and two second resin portions R2 and R3, and the bonding structure of the present disclosure is applied to a bonding portion between the first resin portion R1 and the second resin portion R2 (a bonding region is formed between the first resin portion R1 and the second resin portion R2).

That is, a protruding portion 600 is formed in the first resin portion R1, a recessed portion 601 is formed in the second resin portion R2, and in the structure S4, the protruding portion 600 is fitted into the recessed portion 601, so that the first resin portion R1 and the second resin portion R2 are firmly and integrally bonded to each other (a bonding structure is formed between the first resin portion R1 and the second resin portion R2). In the structure S4, a first resin (part of the first resin portion R1) is present so as to cover the periphery of the bonding portion between the recessed portion 600 and the protruding portion 601. On the other hand, in the bonding portion between the first resin portion R1 and a second resin portion R3, the second resin portion R3 is formed so as to cover the end portion of the second resin portion R2 formed in a spherical shape, and the surfaces thereof are merely in contact with each other (a multi-layered structure is formed between the second resin portion R2 and the second resin portion R3).

The structure S4 can be shaped using the molten resin extrusion shaping method, and a ball joint mechanism can be obtained by a single shaping operation. In addition, after the shaping, a joint surface between the second resin portion R2 and the second resin portion R3 is easily separated, and the second resin portion R2 and the second resin portion R3 can perform a joint motion (arrow A) of the ball joint.

In the structure S4, in the bonding region between the first resin portion R1 and the second resin portion R2, the bonding direction thereof is the Z1-Z2 direction. However, in order to simultaneously shape the bonding portion between the first resin portion R1 and the second resin portion R3 by a single shaping operation, the laminating direction (the moving direction of the platform 20) is also the Z1-Z2 direction.

FIG. 13 is another application example of the fourth embodiment and is an external view of a structure S5 which is a cylinder type joint. The structure S5 which is the cylinder type joint is configured to include two first resin portions R1 and R4 and one second resin portion R2, and the bonding structure of the present disclosure is applied to the bonding portion between the first resin portion R1 and the second resin portion R2 (the bonding region is formed between the first resin portion R1 and the second resin portion R2). As a result, the first resin portion R1 and the second resin portion R2 are firmly and integrally bonded to each other. However, in FIG. 13, the protruding portion and the recessed portion formed in the first resin portion R1 and the second resin portion R2, respectively, are not illustrated by hidden lines.

On the other hand, the bonding portion between the first resin portion R4 and the second resin portion R2 is configured such that an outer circumferential surface of a cylindrical portion at an end portion of the second resin portion R2 is merely in contact with an inner circumferential surface of a cylindrical portion at an end portion of the first resin portion R4.

The structure S5 can be shaped using the molten resin extrusion shaping method, and a cylinder type joint mechanism can be obtained by a single shaping operation. In addition, after the shaping, a joint surface between the first resin portion R4 and the second resin portion R2 is easily separated, and the first resin portion R4 and the second resin portion R2 can perform a joint motion (arrow B) of the cylinder type joint.

The structures S4 and S5 are shaped by combining a bonding structure and a simple multi-layered structure using, for example, ABS resin (first resin material) which is a hard resin material and PE resin (second resin material) which is a soft resin material, and a joint mechanism can be obtained by a single shaping operation. By using this shaping concept, in the molten resin extrusion shaping method, the entire mechanical structure including the movable portion can be produced by a single shaping operation.

The embodiments disclosed herein are illustrative in all respects and are not the basis for a limited interpretation. Accordingly, the technical scope of the disclosure is not to be construed by the foregoing embodiments only, and is defined based on the description of the claims.

1. A multi-layered structure comprising:
a first resin portion shaped of a first resin; and
a second resin portion shaped of a second resin which is a resin material different from the first resin, wherein
the multi-layered structure is shaped by laminating a plurality of layers in a bonding direction,
a bonding region in which both resin materials of the first resin portion and the second resin portion are mixed is provided between the first resin portion and the second resin portion,
in the bonding region, the first resin portion is provided with a protruding portion, the second resin portion is provided with a recessed portion having the same shape as the protruding portion, and the first resin portion and the second resin portion are bonded to each other by fitting the protruding portion into the recessed portion,
the protruding portion includes a plurality of first rod-shaped portions that each extend in the bonding direction and a plurality of second rod-shaped portions that each extend from the first rod-shaped portion from the same position in a direction intersecting the bonding direction,
the second rod-shaped portion is formed to be connected to the plurality of first rod-shaped portions, and
the bonding region has a structure in which a first layer in which the second rod-shaped portion is present and a second layer in which the second rod-shaped portion is not present are repeatedly multi-layered in order along the bonding direction.

2. The multi-layered structure according to claim 1, wherein, in the bonding region, a mixing ratio of the first resin to the second resin changes along the bonding direction, a ratio of the first resin portion decreases from the first resin portion side toward the second resin portion side, and a ratio of the second resin portion increases from the first resin portion side toward the second resin portion side.

3. The multi-layered structure according to claim 1, wherein, in the bonding region, the thickness of the second rod-shaped portion decreases from the first resin portion side toward the second resin portion side.

4. The multi-layered structure according to claim 1, wherein the first resin is a resin material that is relatively harder than the second resin.

5. The multi-layered structure according to claim 4, wherein
the first resin is an ABS resin, and
the second resin is a PP resin or a PE resin.

6. The multi-layered structure according to claim 1, further comprising
at least one first resin portion and at least two second resin portions, or at least two first resin portions and at least one second resin portion, wherein
a bonding structure that forms the bonding region is formed at at least one bonding portion between the first resin portion and the second resin portion, and
the multi-layered structure in which surfaces of the first resin portion and the second resin portion are merely in contact with each other without forming the bonding region is formed at at least one other bonding portion between the first resin portion and the second resin portion.

7. A multi-layered structure comprising:
a first resin portion shaped of a first resin; and
a second resin portion shaped of a second resin which is a resin material different from the first resin, wherein
the multi-layered structure is shaped by laminating a plurality of layers in a bonding direction,
a bonding region in which both resin materials of the first resin portion and the second resin portion are mixed is provided between the first resin portion and the second resin portion,
in the bonding region, the first resin portion is provided with a protruding portion, the second resin portion is provided with a recessed portion having the same shape as the protruding portion, and the first resin portion and the second resin portion are bonded to each other by fitting the protruding portion into the recessed portion,
the protruding portion includes a plurality of first rod-shaped portions that each extend in the bonding direction and a plurality of lump portions each formed to surround a periphery of a side surface of a part of the first rod-shaped portion in the longitudinal direction, and
the bonding region has a structure in which a layer in which the lump portion is present and a layer in which the lump portion is not present are repeatedly multi-layered in order along the bonding direction.

8. The multi-layered structure according to claim 7, wherein, in the bonding region, a mixing ratio of the first resin to the second resin changes along the bonding direction, a ratio of the first resin portion decreases from the first resin portion side toward the second resin portion side, and a ratio of the second resin portion increases from the first resin portion side toward the second resin portion side.

9. The multi-layered structure according to claim 7, wherein, in the bonding region, the size of the lump portion decreases from the first resin portion side toward the second resin portion side.

10. The multi-layered structure according to claim 7, wherein the first resin is a resin material that is relatively harder than the second resin.

11. The multi-layered structure according to claim 10, wherein
the first resin is an ABS resin, and
the second resin is a PP resin or a PE resin.

12. The multi-layered structure according to claim 2, further comprising
at least one first resin portion and at least two second resin portions, or at least two first resin portions and at least one second resin portion, wherein
a bonding structure that forms the bonding region is formed at at least one bonding portion between the first resin portion and the second resin portion, and
the multi-layered structure in which surfaces of the first resin portion and the second resin portion are merely in contact with each other without forming the bonding region is formed at at least one other bonding portion between the first resin portion and the second resin portion.

13. A method of manufacturing a multi-layered structure, the multi-layered structure comprising a first resin portion shaped of a first resin and a second resin portion shaped of a second resin which is a resin material different from the first resin, and the multi-layered structure being shaped by laminating a plurality of layers in a bonding direction, the method comprising:
providing a bonding region in which both resin materials of the first resin portion and the second resin portion are mixed between the first resin portion and the second resin portion;
in the bonding region,
providing the first resin portion with a protruding portion,
providing the second resin portion with a recessed portion having the same shape as the protruding portion, and
bonding the first resin portion and the second resin portion to each other by fitting the protruding portion into the recessed portion;
the protruding portion including a plurality of first rod-shaped portions that each extend in the bonding direction and a plurality of second rod-shaped portions that each extend from the first rod-shaped portion from the same position in a direction intersecting the bonding direction,
forming the second rod-shaped portion to be connected to the plurality of first rod-shaped portions; and
forming the bonding region by repeatedly laminating a first layer in which the second rod-shaped portion is present and a second layer in which the second rod-shaped portion is not present in order along the bonding direction.

14. A method of manufacturing a multi-layered structure, the multi-layered structure comprising a first resin portion shaped of a first resin and a second resin portion shaped of a second resin which is a resin material different from the first resin, and the multi-layered structure being shaped by laminating a plurality of layers in a bonding direction, the method comprising:
providing a bonding region in which both resin materials of the first resin portion and the second resin portion are mixed between the first resin portion and the second resin portion;
in the bonding region,
providing the first resin portion with a protruding portion,
providing the second resin portion with a recessed portion having the same shape as the protruding portion, and
bonding the first resin portion and the second resin portion to each other by fitting the protruding portion into the recessed portion;
the protruding portion including a plurality of first rod-shaped portions that each extend in the bonding direction and a plurality of lump portions each formed to surround a periphery of a side surface of a part of the first rod-shaped portion in the longitudinal direction, and
forming the bonding region by repeatedly laminating a layer in which the lump portion is present and a layer in which the lump portion is not present in order along the bonding direction.
